(19) United States
(12) Patent Application Publication
(10) Pub. No.: US 2019/0255943 A1
(43) Pub. Date: Aug. 22, 2019

(54) Transmission Assembly for a Vehicle, and Vehicle Having the Transmission Assembly

(71) Applicant: ZF Friedrichshafen AG, Friedrichshafen (DE)

(72) Inventors: Patrick Kniess, Aulendorf (DE); Detlef Baasch, Oberteuringen (DE)

(21) Appl. No.: 16/347,717

(22) PCT Filed: Oct. 4, 2017
(86) PCT No.: PCT/EP2017/075109

§ 371 Date: May 6, 2019

(30) Foreign Application Priority Data
Nov. 8, 2016 (DE) 10 2016 221 819.0

(51) Int. Cl. B60K 17/35; F16H 48/24

(52) U.S. Cl. CPC B60K 17/3515; F16H 48/24

(57) ABSTRACT

A transmission arrangement 2 for a vehicle 1 includes a first output shaft arrangement 11 and a second output shaft arrangement 12. The first output shaft arrangement 11 includes a first output shaft 13 and an intermediate shaft 14, and the second output shaft arrangement 12 includes a second output shaft 15. A differential device 3 distributes a drive torque to the first output shaft arrangement 11 and to the second output shaft arrangement 12. The differential device 3 includes a differential cage 6. A coupling unit 22 selectively couples the intermediate shaft 14 to the first output shaft 13 in a driving manner. The differential cage 6 is couplable to the first output shaft arrangement 11 in a driving manner through the coupling unit 22.

### FIELD OF THE INVENTION

The invention relates generally to a transmission arrangement for a vehicle, including a first output shaft arrangement and a second output shaft arrangement. The first output shaft arrangement includes a first output shaft and an intermediate shaft, and the second output shaft arrangement includes a second output shaft. A differential device distributes a drive torque to the first output shaft arrangement and the second output shaft arrangement. The differential device includes a differential cage. A coupling unit couples the intermediate shaft to the output shaft in a driving manner. Moreover, the invention relates to a vehicle that includes the transmission arrangement.

### BACKGROUND

Differentials are often utilized in vehicles for distributing a drive torque to two output shafts. Bevel gear differentials, in particular, make it possible, with the aid of differential pinions, for the two output shafts to be turned relative to one another. Therefore, for example, different angular speeds can be compensated for during cornering maneuvers by vehicles. In particular, a drive axle can be decoupled from the differential with the aid of form-locking or friction-locking elements.

Publication DE 10 2012 004 931 A1, which is the closest prior art, discloses a method for engaging and disengaging an all-wheel drive of motor vehicles, in which a drive axle can be automatically decoupled from the prime mover at a lower speed of the motor vehicle and at a lower output torque of the variable speed transmission by disengaging at least one separating clutch, wherein the decoupling is controlled by an open-loop system by evaluating the engaged gear in the variable speed transmission. The drive axle and its axle differential are completely decoupled from the prime mover including the variable speed transmission and from the corresponding wheels of the motor vehicle with the aid, in particular, of three separating clutches arranged on the input side and on the output side.

### SUMMARY OF THE INVENTION

Example aspects of the invention provide a transmission arrangement for a vehicle, which is cost-effective to produce and makes it possible to easily switch between different operating conditions of the differential device.

According to example aspects of the invention, a transmission arrangement for a vehicle is provided. In particular, the vehicle is a motor vehicle, preferably a passenger car or a truck, or a rail vehicle. In particular, the transmission arrangement is suitable and/or designed for an all-wheel-driven vehicle. It is particularly preferred when the transmission arrangement is connected to an engine in a driving manner. In particular, the engine is designed as an internal combustion engine, particularly preferably as a gasoline or diesel engine, and/or as an electric motor.

The transmission arrangement includes a first output shaft arrangement and a second output shaft arrangement. In particular, the first output shaft arrangement and the second output shaft arrangement form an axle for the vehicle. Preferably, the axle is a front axle or a rear axle or a tandem axle. In particular, the two output shaft arrangements define a main axis via their axis of rotation.

The first output shaft arrangement includes a first output shaft and an intermediate shaft. In particular, the first output shaft and/or the intermediate shaft rotate/rotates about the main axis. Preferably, the first output shaft is connected to a first vehicle wheel. It is particularly preferred when the first output shaft arrangement is formed by the first output shaft and the intermediate shaft In particular, the first output shaft and the intermediate shaft are designed as two individual shafts.

The second output shaft arrangement includes a second output shaft. In particular, the second output shaft rotates about the main axis. Preferably, the second output shaft arrangement is formed by the second output shaft. It is particularly preferred when the second output shaft is connected to a second vehicle wheel.

The transmission arrangement includes a differential device for distributing a drive torque to the first output shaft arrangement and the second output shaft arrangement. In particular, the differential device is connected to the engine in a driving manner via an input shaft. Preferably, the drive torque is transmitted via the engine to the differential device with the aid of the input shaft. In particular, the differential device is designed as an axle differential. For example, the differential device is designed as a spur gear differential or as a helical gear differential. It is particularly preferred, however, when the differential device is designed as a bevel gear differential.

The differential device includes a differential cage. In particular, the differential cage has the function of transmitting the drive torque of the engine to the two output shaft arrangements. Preferably, the power split of the drive torque via the differential cage to the two output shaft arrangements corresponds to a ratio of 50:50. In particular, the differential device includes a differential housing The differential cage is arranged in the differential housing. In particular, the two output shaft arrangements are rotatably mounted in the differential housing.

The transmission arrangement, in particular the first output shaft arrangement, includes a coupling unit for coupling the intermediate shaft to the first output shaft in a driving manner. In particular, the coupling unit is controlled by an open-loop system in an automatic and/or automated manner. Preferably, the coupling unit has the function of coupling the intermediate shaft and the first output shaft to one another in a rotationally fixed manner and, alternatively, decoupling the intermediate shaft and the first output shaft. As a result of the coupling, in particular, a turning motion and/or the drive torque are/is transmitted from the first output shaft to the intermediate shaft or from the intermediate shaft to the first output shaft. In the decoupled condition, the first output shaft and the intermediate shaft can rotate independently of one another.

Within the scope of the invention, it is provided that the differential cage can be coupled to the first output shaft arrangement in a driving manner with the aid of the coupling unit. Therefore, the differential cage can be rotationally fixed to or, alternatively, decoupled from the first output shaft and/or the intermediate shaft. In particular, the coupling of the first output shaft arrangement to the differential cage has the function of blocking a relative movement of the two vehicle wheels. In particular, the coupling unit is actuated with the aid of an actuator.

Optionally, in addition, the second output shaft arrangement includes a second intermediate shaft. The second intermediate shaft and the second output shaft are unseparable and/or always connected to one another in a driving manner.

In certain example embodiments, an advantage of the invention is that, due to the decoupling and/or coupling of the first output shaft arrangement and the coupling and/or decoupling of the differential device, in particular of the differential cage, a simple embodiment of a transmission arrangement is formed, which can be switched between at least three different engagement conditions. Due to the simple embodiment, in addition, a cost-effective production of the transmission arrangement including the at least three different engagement conditions is possible.

In one preferred structural embodiment of the invention, the transmission arrangement includes three coupling gears. A first coupling gear is connected to the intermediate shaft in a driving, in particular rotationally fixed, manner; a second coupling gear is connected to the first output shaft in a driving, in particular rotationally fixed, manner; and a third coupling gear is connected to the differential cage in a driving, in particular rotationally fixed, manner. It is particularly preferred when the coupling unit couples or decouples the first coupling gear and/or the second coupling gear and/or the third coupling gear with respect to one another.

In particular, the coupling gears have a profile, wherein the coupling unit preferably forms a contour partner with the coupling gears. For example, the coupling gears are designed as gearwheels, wherein the tooth system is designed as webs or teeth or grooves extending axially with respect to the main axis. In particular, the coupling unit is displaceable in the axial direction with respect to the main axis. Preferably, the coupling unit, together with the first coupling gear and/or the second coupling gear and/or the third coupling gear, forms a positive engagement in the circumferential direction with respect to the axis of rotation. For example, the coupling unit is designed as a synchronizer sleeve.

In one preferred embodiment, the third coupling gear is designed as a ring gear and/or the third coupling gear is connected to the differential cage via a hollow shaft. In particular, the intermediate shaft is coaxially and/or concentrically arranged in the ring gear and/or in the hollow shaft.

In a first possible operating condition, the coupling unit is in a disconnect engagement position, wherein the coupling unit is disengaged and the first output shaft, the differential cage, and the intermediate shaft are decoupled from one another and/or are separated from one another with respect to a driving force. In the first possible operating condition in the disconnect engagement position, the first output shaft and the second output shaft rotate independently and/or freely with respect to one another. The disconnect engagement position has the function, in particular, of disconnecting a driven axle. Due to the fact that the differential cage, in particular in the disconnect engagement position, does not rotate about the main axis, churning losses of the differential device are prevented. In particular, the fuel consumption is reduced due to the disconnect engagement position. For example, the coupling unit is connected to the first coupling gear, but is disconnected from the second coupling gear and the third coupling gear with respect to a driving force.

In a second possible operating condition, the coupling unit is in a connect-open engagement position, wherein the first output shaft and the intermediate shaft are coupled to one another in a rotationally fixed manner with the aid of the coupling unit, and the differential cage is decoupled from the coupling unit. In particular, the differential cage is coupled to the two output shaft arrangements via at least one differential bevel gear, so that the drive torque of the engine is transmitted to the two output shafts via the at least one differential bevel gear. In particular, the coupling unit is coupled to the first coupling gear and to the second coupling gear.

In the second possible operating condition and/or in the connect-open engagement position, the differential device is designed as an open differential device and/or the differential device compensates for different rotational speeds of the first output shaft and the second output shaft. The connect-open engagement position has the function, in particular, of compensating for different rotational speeds of the vehicle wheels during a cornering maneuver by the vehicle. In particular, due to the connect-open engagement position, a slip as well as a torsional stress of the vehicle wheels during the cornering maneuver is avoided. For example, the coupling unit is connected to the first coupling gear and the second coupling gear, but is decoupled from the third coupling gear with respect to a driving force.

In a third possible operating condition, the coupling unit is in a connect-lock engagement position, wherein the first output shaft, the intermediate shaft, and the differential cage are coupled to one another in a rotationally fixed manner with the aid of the coupling unit. In particular, the differential cage is coupled to the first output shaft arrangement with the aid of the coupling unit, so that the drive torque of the engine is transmitted via the differential cage to the first output shaft arrangement and to the second output shaft arrangement. Preferably, the at least one differential bevel gear is interlocked, so that the differential device operates in a direct drive condition. It is particularly preferred when the coupling unit is coupled in a rotationally fixed manner to the first coupling gear and to the second coupling gear and to the third coupling gear.

In the third possible operating condition and/or in the connect-lock engagement position of the coupling unit, the differential device is designed as a locked differential device and/or the differential device transfers identical rotational speeds to the first output shaft and the second output shaft. The connect-lock engagement position has the function, in particular, of distributing the drive torque of the engine equally to the two vehicle wheels. In particular, due to the connect-lock engagement position, no relative rotational speed differences are transferred between the two vehicle wheels.

In one structural embodiment, the coupling unit is designed as a form-locking or friction-locking or force-locking coupling unit. For example, the coupling unit is a toothed clutch or a dog clutch or a beam coupling. In particular, the coupling unit is axially movable and/or rotationally fixed.

In one further structural embodiment, the transmission arrangement includes a drive gear for transmitting the drive torque to the differential device. In particular, the drive gear is rotationally fixed to the input shaft. Preferably, the drive gear is arranged in the differential housing. In particular, the drive gear is designed as a gearwheel, preferably as a spur gear or as a bevel gear. For example, the gearwheel includes helical gearing or involute gearing or cycloidal gearing.

The differential device includes a ring gear. Preferably, the ring gear is arranged in the differential housing. Preferably, the ring gear has the same type of toothing as the drive gear. For example, the ring gear is designed as a gearwheel, preferably as a bevel gear or as a crown gear or as a spur gear. In particular, the second output shaft arrangement, in particular the second output shaft, is coaxially and/or concentrically guided through the ring gear and/or is rotatably mounted.

The differential cage is rotationally fixed to the ring gear. In particular, the differential cage and the ring gear are one piece or are integrally connected to one another. In particular, the first output shaft arrangement, preferably the intermediate shaft, has been guided through the differential cage and/or is rotatably mounted. The drive gear is coupled to the ring gear. It is particularly preferred when the drive gear transmits the drive torque to the ring gear. In particular, the drive gear is engaged with the ring gear.

In one possible structural embodiment, the differential cage includes at least one differential bevel gear for compensating for rotational speed differences of the two output shafts. In particular, the differential bevel gear is rotatably mounted in the differential cage. In particular, the differential bevel gear is designed as a bevel gear. In particular, the differential cage includes more than two, in particular four, differential bevel gears. In particular, the differential bevel gears are uniformly spaced apart from one another in the circumferential direction with respect to the main axis.

The intermediate shaft includes a first side gear and the second output shaft includes a second side gear. In particular, the first side gear is rotationally fixed to the intermediate shaft and/or the second side gear is rotationally fixed to the second output shaft. Preferably, the two side gears are designed as bevel gears. The two side gears are coupled to the at least one differential bevel gear. Preferably, the differential cage transmits the drive torque to the differential bevel gear and, therefore, to the two side gears. Depending on the engagement position of the coupling unit, the drive torque is distributed equally or differently to the two side gears and, therefore, to the two output shaft arrangements. It is particularly preferred when the two side gears are arranged in the differential cage.

In the first possible operating condition in the disconnect engagement position, a torque path extends from the drive gear via the ring gear and ends in the differential device. In particular, the drive torque is transmitted only to the intermediate shaft, and so no drive torque is transmitted to the first output shaft and the second output shaft.

In the second possible operating condition in the connect-open engagement position, a torque path extends from the drive gear via the ring gear, the differential cage, and the differential bevel gear to the first output shaft and the second output shaft. In particular, the torque path extends to the differential bevel gear, wherein the torque path splits at the differential bevel gear and ends in the first output shaft and the second output shaft. In particular, the drive torque is distributed to the two vehicle wheels equally during driving straight ahead, and is distributed to the two vehicle wheels differently during a cornering maneuver.

In the third possible operating condition in the connect-lock engagement position, a torque path extends from the drive gear via the ring gear, the differential cage, and the differential bevel gear to the first output shaft and the second output shaft, wherein a partial torque path extends in parallel to the torque path via the differential cage and the coupling unit to the first output shaft. In particular, the differential bevel gear is interlocked by the first side gear. Preferably, the torque path extends to the differential cage, wherein the torque path splits at the differential cage and at the differential bevel gear and ends in the first output shaft and in the second output shaft. It is particularly preferred when the first output shaft and the second output shaft rotate at the same rotational speed in the circumferential direction with respect to the main axis. It is particularly preferred when the drive torque is distributed equally to the two vehicle wheels.

One further object of the invention is a vehicle that includes the transmission arrangement of the type described above. Optionally, in addition, the vehicle may include at least one further transmission arrangement of the type described above.

### BRIEF DESCRIPTION OF THE DRAWINGS

Further features, advantages, and effects of the invention result from the following description of preferred exemplary embodiments of the invention. Wherein:

FIG. 1 shows a vehicle including a transmission arrangement in a disconnect engagement position as an exemplary embodiment of the invention;

FIG. 2 shows the vehicle including the transmission arrangement in a connect-open engagement position; and

FIG. 3 shows the vehicle including the transmission arrangement in a connect-lock engagement position.

Mutually corresponding or identical parts are provided with the same reference characters in the figures.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

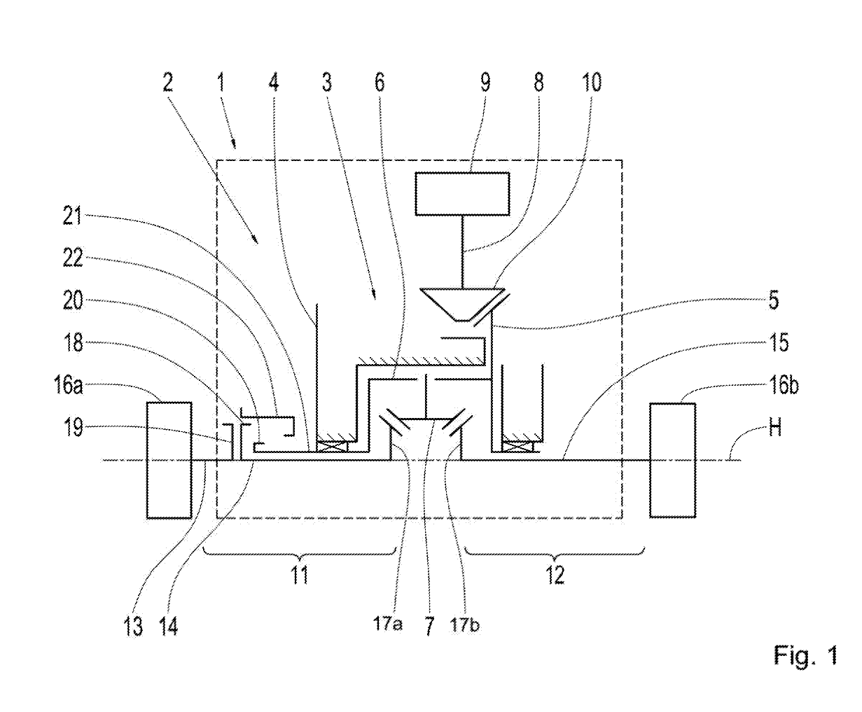

FIG. 1 shows a highly simplified schematic of a vehicle 1 including a transmission arrangement 2 in a disconnect engagement position as a first exemplary embodiment of the invention. For example, the vehicle 1 is a passenger car or a truck. In the representation shown, a driven vehicle axle, for example, a front axle, is represented. For example, the vehicle 1 includes at least one further axle.

The transmission arrangement 2 includes a differential device 3, wherein the differential device 3 is designed as a bevel gear drive. The differential device 3 includes a differential housing 4, wherein a ring gear 5, including a differential cage 6 attached thereto, is arranged in the differential housing 4. For example, the differential cage 6 is connected to the ring gear 5 in an integrally joined and/or form-locking and/or force-locking manner. In particular, the ring gear 5 and the differential cage 6 are rotatably mounted in the differential housing 4. The differential device 3 includes at least one differential bevel gear 7. For example, the differential device 3 includes four differential bevel gears which are uniformly spaced apart from one another. The differential bevel gear 7 is arranged and rotatably mounted in the differential cage 6.

The transmission arrangement 2 includes an input shaft 8 and a drive gear 10. Moreover, the vehicle 1 includes an engine 9, for example, an internal combustion engine and/or an electric motor. The input shaft 8 is connected to the engine 9 in a driving manner via an axial end. For example, the input shaft 8 is a cardan shaft. The other axial end of the input shaft 8 is rotationally fixed to the drive gear 10. The drive gear 10 and the ring gear 5 are designed, for example, as bevel gears and are engaged with one another.

The transmission arrangement 2 includes a first output shaft arrangement 11 and a second output shaft arrangement 12. The two output shaft arrangements 11, 12 together form the vehicle axle of the vehicle 1. The two output shaft arrangements 11, 12 define a main axis H. The first output shaft arrangement 11 is formed by a first output shaft 13 and an intermediate shaft 14. The second output shaft arrangement 12 is formed by a second output shaft 15.

The vehicle 1 includes a first vehicle wheel 16a and a second vehicle wheel 16b. The first vehicle wheel 16a is connected to the first output shaft 13 and the second vehicle wheel 16b is connected to the second output shaft 15. The two output shafts 13, 15 and the intermediate shaft 14 rotate about the main axis H during an operating condition of the vehicle 1.

The intermediate shaft 14 includes a first side gear 17a at one axial end and the second output shaft 15 includes a second side gear 17b at one axial end. The two side gears 17a, 17b are designed, for example, as bevel gears and are arranged in the differential housing 4, in particular in the differential cage 6. Each of the two side gears 17a, 17b is in intermeshing contact with the differential bevel gear 7. The intermediate shaft 14 is guided through the differential cage 6 and the differential housing 4 and the second output shaft 15 is guided through the ring gear 5 and the differential housing 4.

The intermediate shaft 14 includes a first coupling gear 18 at an opposite axial end. The first output shaft 13 includes a second coupling gear 19 at an opposite axial end. The differential cage 6 includes a hollow shaft 21, wherein the hollow shaft 21 is rotatably mounted in the differential housing 4. The intermediate shaft 14 is guided through the hollow shaft 21. The hollow shaft 21 includes a third coupling gear 20. For example, the first coupling gear 18, the second coupling gear 19, and the third coupling gear 20 are connected to the intermediate shaft 14, the first output shaft 13, and the hollow shaft 21, respectively, in a form-locking and/or integrally joined and/or force-locking manner. The coupling gears 18, 19, 20 are designed, for example, as spur gears.

The transmission arrangement 2 includes a coupling unit 22. The coupling unit 22 is, for example, a form-locking dog clutch. The hollow shaft 21 extends in parallel to the main axis H from the differential cage 6 through the differential housing 4 in the direction of the coupling unit 22. The coupling unit 22 is axially displaceable with respect to the main axis H. For example, the coupling unit 22 forms a contour partner with an external gearing of the coupling gears 18, 19, 20, and so, in the event of a coupling, a positive engagement is formed in the circumferential direction with respect to the main axis H. The coupling unit 22 is displaceable into three different engagement positions. In the disconnect engagement position shown, the coupling unit 22 is coupled only to the first coupling gear 18, and so the first output shaft 13 and the hollow shaft 21, and the differential cage 6, are decoupled from the intermediate shaft 14.

In this operating condition of the vehicle 1, the two vehicle wheels 16a, 16b rotate freely with respect to one another. The first vehicle wheel 16a rotates freely with the aid of the first output shaft 13. The second vehicle wheel 16b rotates with the aid of the second output shaft 15, the second side gear 17b, the differential bevel gear 7, the first side gear 17a, and the intermediate shaft 14. The differential cage 6 is in the disconnect engagement position, and so the wheel rolling motions of the second vehicle wheel 16b are transmitted only to the intermediate shaft 14.

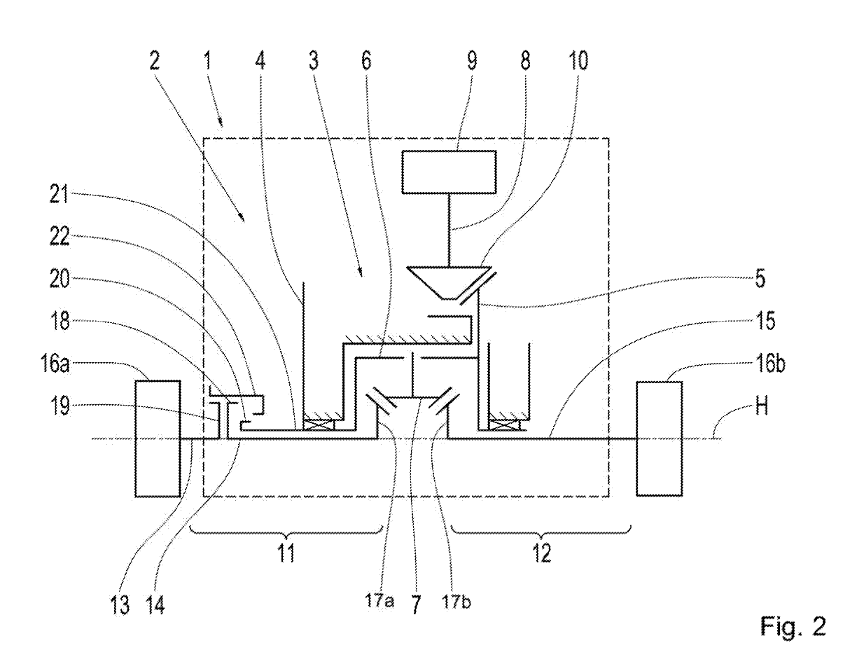

FIG. 2 shows, in the same representation as in FIG. 1, the vehicle 1 including the transmission arrangement 2 in a connect-open engagement position. The coupling unit 22 has been axially displaced in the direction of the second coupling gear 19. The first coupling gear 18 and the second coupling gear 19 are coupled to one another in a rotationally fixed manner with the aid of the coupling unit 22. Therefore, the first output shaft 13 and the intermediate shaft 14 are coupled to one another in a rotationally fixed manner, and so the differential device 3 forms an open differential.

In this operating condition of the vehicle 1, the two vehicle wheels 16a, 16b jointly rotate with the aid of the two output shaft arrangements 11, 12 and the differential bevel gear 7. Therefore, different rotational speeds of the two vehicle wheels 16a, 16b are compensated for during a cornering maneuver of the vehicle 1. The first vehicle wheel 16a rotates with the aid of the first output shaft 13, the intermediate shaft 14, and the first side gear 17a. The second vehicle wheel 16b rotates with the aid of the second output shaft 15 and the second side gear 17b.

The differential cage 6 rotates, in the connect-open engagement position, in the circumferential direction with respect to the main axis H. A drive torque is transmitted from the engine 9 via the input shaft 8, the drive gear 10, and the ring gear 5 to the differential cage 6 and, therefore, to the differential bevel gear 7. Therefore, the drive torque is distributed with the aid of the differential bevel gear to the two side gears 17a, 17b and to the two output shafts 13, 15.

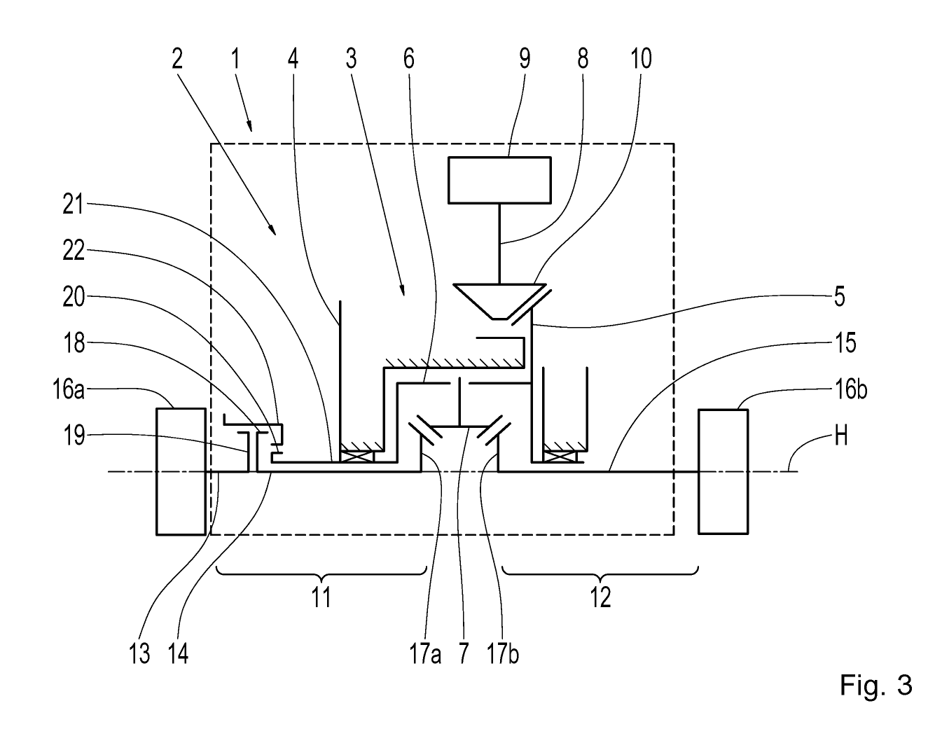

FIG. 3 shows, in the same representation as in FIG. 1, the vehicle 1 including the transmission arrangement 2 in a connect-lock engagement position. The coupling unit 22 has been axially displaced further in the direction of the second coupling gear 19. The first coupling gear 18, the second coupling gear 19, and the third coupling gear 20 are coupled to one another with the aid of the coupling unit 22. Therefore, the first output shaft 13, the intermediate shaft 14, and the differential cage 6 are coupled to one another in a rotationally fixed manner, and so the differential device 3 forms a locked differential.

In this operating condition of the vehicle 1, the two vehicle wheels 16a, 16b rotate together with the aid of the two output shaft arrangements 11, 12 and the differential device 3 and the differential cage 6. Therefore, the two vehicle wheels 16a, 16b rotate at the same rotational speed, since the differential device 3 operates in a direct drive condition. The first vehicle wheel 16a rotates with the aid of the first output shaft 13, the intermediate shaft 14, and the first side gear 17a, as well as with the aid of the hollow shaft 21 and the differential cage 6. The second vehicle wheel 16b rotates with the aid of the second output shaft 15 and the second side gear 17b.

The differential cage 6, in the connect-lock engagement position, rotates in the circumferential direction with respect to the main axis H. The drive torque is transmitted from the engine 9 via the input shaft 8, the drive gear 10, and the ring gear 5 to the differential cage 6 and, therefore, to the differential bevel gear 7 and the first output shaft arrangement 11. Therefore, the drive torque is distributed equally to the two side gears 17a, 17b and the two output shafts 13, 15, wherein no relative rotational speed differences are compensated for and the differential device 3 is locked.

Modifications and variations can be made to the embodiments illustrated or described herein without departing from the scope and spirit of the invention as set forth in the appended claims.

### REFERENCE CHARACTERS

1 vehicle
2 transmission arrangement
3 differential device
4 differential housing
5 ring gear
6 differential cage
7 differential bevel gear
8 input shaft
9 engine
10 drive gear
11 first output shaft arrangement
12 second output shaft arrangement
13 first output shaft
14 intermediate shaft
15 second output shaft
16a first vehicle wheel
16b second vehicle wheel
17a first side gear
17b second side gear
18 first coupling gear
19 second coupling gear
20 third coupling gear
21 hollow shaft
22 coupling unit

1-15: (canceled)

16. A transmission arrangement (2) for a vehicle (1), comprising:
a first output shaft arrangement (11) and a second output shaft arrangement (12), the first output shaft arrangement (11) including a first output shaft (13) and an intermediate shaft (14), the second output shaft arrangement (12) including a second output shaft (15);
a differential (3) for distributing a drive torque to the first output shaft arrangement (11) and to the second output shaft arrangement (12), the differential (3) including a differential cage (6); and
a coupling unit (22) for selectively coupling the intermediate shaft (14) to the first output shaft (13) in a driving manner,
wherein the differential cage (6) is couplable to the first output shaft arrangement (11) in a driving manner through the coupling unit (22).

17. The transmission arrangement (2) of claim 16, wherein, in a disconnect engagement position of the coupling unit (22), the first output shaft (13), the differential cage (6), and the intermediate shaft (14) are decoupled from one another.

18. The transmission arrangement (2) of claim 17, wherein, in the disconnect engagement position of the coupling unit (22), the first output shaft (13) and the second output shaft (15) turn independently of one another.

19. The transmission arrangement (2) of claim 16, wherein, in a connect-open engagement position of the coupling unit (22), the first output shaft (13) and the intermediate shaft (14) are coupled to one another through the coupling unit (22) and the differential cage (6) is decoupled from the coupling unit (22).

20. The transmission arrangement (2) of claim 19, wherein, in the connect-open engagement position of the coupling unit (22), the differential (3) is an open differential and/or the differential (3) compensates for different rotational speeds of the first output shaft (13) and the second output shaft (15).

21. The transmission arrangement (2) of claim 20, wherein, in a connect-lock engagement position of the coupling unit (22), the first output shaft (13), the intermediate shaft (14), and the differential cage (6) are coupled to one another through the coupling unit (22).

22. The transmission arrangement (2) of claim 21, wherein, in the connect-lock engagement position of the coupling unit (22), the differential (3) is a locked differential and/or the differential (3) transmits identical rotational speeds to the first output shaft and the second output shaft.

23. The transmission arrangement (2) of claim 16, wherein the coupling unit (22) is a form-locking, friction-locking or force-locking coupling unit.

24. The transmission arrangement (2) of claim 16, wherein the differential (3) is a bevel gear differential.

25. The transmission arrangement (2) of claim 16, wherein:
the transmission arrangement (2) comprises a drive gear (10) for transmitting a drive torque to the differential (3);
the differential (3) comprises a ring gear (5);
the differential cage (6) is rotationally fixed to the ring gear (5); and
the drive gear (10) is coupled to the ring gear (5).

26. The transmission arrangement (2) of claim 25, wherein, in a disconnect engagement position of the coupling unit (22), a torque path extends from the drive gear (10) via the ring gear (5) and ends in the differential (3).

27. The transmission arrangement (2) of claim 25, wherein, in a connect-open engagement position of the coupling unit (22), a torque path extends from the drive gear (10) via the ring gear (5), the differential cage (6), and the differential bevel gear (7) to the first output shaft (13) and the second output shaft (15).

28. The transmission arrangement (2) of claim 25, wherein, in a connect-lock engagement position of the coupling unit (22), a torque path extends from the drive gear (10) via the ring gear (5), the differential cage (6), and the differential bevel gear (7) to the first output shaft (13) and the second output shaft (15), and a partial torque path extends in parallel to the torque path via the differential cage (6) and the coupling unit (22) to the first output shaft (13).

29. The transmission arrangement (2) of claim 16, wherein:
the differential cage (6) comprises at least one differential bevel gear (7) for compensating for rotational speed differences of the two output shafts (13, 15);
the intermediate shaft (14) comprises a first side gear (17a);
the second output shaft (15) comprises a second side gear (17b); and
the first and second side gears (17a, 17b) are coupled to the differential bevel gear (7).

30. The transmission arrangement (2) of claim 29, wherein, in a disconnect engagement position of the coupling unit (22), a torque path extends from the drive gear (10) via the ring gear (5) and ends in the differential (3).

31. The transmission arrangement (2) of claim 29, wherein, in a connect-open engagement position of the coupling unit (22), a torque path extends from the drive gear (10) via the ring gear (5), the differential cage (6), and the differential bevel gear (7) to the first output shaft (13) and the second output shaft (15).

32. The transmission arrangement (2) of claim 29, wherein, in a connect-lock engagement position of the coupling unit (22), a torque path extends from the drive gear (10) via the ring gear (5), the differential cage (6), and the differential bevel gear (7) to the first output shaft (13) and the second output shaft (15), and wherein a partial torque path extends in parallel to the torque path via the differential cage (6) and the coupling unit (22) to the first output shaft (13).

33. A vehicle (1) comprising the transmission arrangement (1) of claim 16.
